(19) United States
(12) Patent Application Publication
(10) Pub. No.: US 2025/0029186 A1
(43) Pub. Date: Jan. 23, 2025

(54) DYNAMIC ELECTRONIC INSURANCE APPLICATION WORKFLOW SYSTEM

(71) Applicant: Berkley Insurance Company, Greenwich, CT (US)

(72) Inventors: Nir GABAY, Voorhees, NJ (US); Anthony Mark HOMACK, Glenside, PA (US); Isaac Lamont JACKSON, Glenside, PA (US); Louis Mark CHILSON, Jr., Levittown, PA (US); Timothy FRICK, Marlton, NJ (US); Robert Michael CONVERY, III, Philadelphia, PA (US)

(73) Assignee: Berkley Insurance Company, Greenwich, CT (US)

(21) Appl. No.: 18/776,520

(22) Filed: Jul. 18, 2024

Related U.S. Application Data
(60) Provisional application No. 63/514,310, filed on Jul. 18, 2023.

(51) Int. Cl. G06Q 40/08; G06Q 10/0633

(52) U.S. Cl. CPC G06Q 40/08; G06Q 10/0633

(57) ABSTRACT

A method is implemented by a system including a processor and a memory storing processor executable code for a customization engine is provided. The customization engine generates a customer specific insurance application specific to a first user and provides access to the first user based on an invitation. The invitation include a unique customer link to the customer specific insurance application. The invitation is initiated by an input from a second user. The customization engine dynamically builds and fills-in the customer specific insurance application based on inputs from the first user and on automatically populating customer specific insurance application with non-standardized data to provide a completed customer specific insurance application. The customization engine provides a customized insurance request based on the completed customer specific insurance application to a third user and facilitates insurance coverage from the third user for the first user based on the customized insurance request.

### CROSS-REFERENCE TO RELATED APPLICATIONS

This application claims priority to provisional U.S. Application No. 63/514,310, filed Jul. 18, 2023, the contents of which are hereby incorporated by reference.

### FIELD OF USE

Disclosed herein is a dynamic electronic insurance application workflow system (“system”) to provide a database-driven insurance application and approval process for a customer seeking insurance from an insurance company.

### BACKGROUND

Today, insurance companies have computing systems that handle hundreds of different types of insurance requests for different users. Conventional insurance software of these types of computing systems generally utilize static forms that often fail to fit the need of any particular insurance request. Note that utilizing static forms in a serial data gathering fashion complements a serial nature of insurance processing done by a human (e.g., completing a first form by hand, then an appendix by hand, then a second appendix by hand, etc.). Additionally, conventional insurance software can be slow and cumbersome to operate, consume excessive processing power, overutilize memory, and be prone to processor errors that lock computing resources and prevent proper functioning of the computing systems. For instance, conventional insurance software generates duplicate documentation with multiple appendix forms as user circumstances increase in complexity, which occupies memory and bogs down computing systems. Similarly, when any particular insurance request is completed as a manual process by hand, humans generate duplicate documentation with multiple appendix forms in serial fashion as user circumstances increase in complexity (i.e., there is no way to dynamically change the first form).

What is needed is a solution that can provide a dynamically customized database-driven insurance application and approval process for a customer seeking insurance from an insurance company, while also improving the operations of the computing systems.

### SUMMARY

According to one or more embodiments, a method is provided. The method is implemented by a system including at least one processor and a memory storing processor executable code for a customization engine. In implementing the method, the customization engine generates a customer specific insurance application specific to a first user and provides access to the first user based on an invitation. The invitation includes a unique customer link to the customer specific insurance application. The invitation is initiated by an input from a second user. The customization engine dynamically builds and fills-in the customer specific insurance application based on inputs from the first user and automatically populates customer specific insurance application with non-standardized data to provide a completed customer specific insurance application. The customization engine provides a customized insurance request based on the completed customer specific insurance application to a third user and facilitates insurance coverage from the third user for the first user based on the customized insurance request

According to one or more embodiments or any of the method embodiments herein, the customization engine can be implemented as an apparatus, a system, and a computer program product.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 depicts a process according to one or more exemplary embodiments;

FIG. 2 depicts a diagram of a system according to one or more embodiments;

FIG. 3 depicts a diagram of a computing environment according to one or more exemplary embodiments;

FIG. 4 depicts a user interface according to one or more exemplary embodiments;

FIG. 5 depicts a user interface according to one or more exemplary embodiments;

FIG. 6 depicts a user interface according to one or more exemplary embodiments;

FIG. 7 depicts a user interface according to one or more exemplary embodiments;

FIG. 8 depicts a user interface according to one or more exemplary embodiments;

FIG. 9 depicts a user interface according to one or more exemplary embodiments;

FIG. 10 depicts a user interface according to one or more exemplary embodiments;

FIG. 11 depicts a user interface according to one or more exemplary embodiments;

FIG. 12 depicts a user interface according to one or more exemplary embodiments;

FIG. 13 depicts a user interface according to one or more exemplary embodiments;

FIG. 14 depicts a user interface according to one or more exemplary embodiments; and

FIG. 15 depicts operation examples of a system according to one or more exemplary embodiments.

### DETAILED DESCRIPTION

The disclosure herein generally relates to a dynamic electronic insurance application workflow system (“system”). More particularly, the disclosure herein provides a system that executes one or more operations of a dynamic electronic insurance application workflow in combination and/or in any order to provide a database driven insurance application and approval process for a customer seeking insurance from an insurance company. The system enables one or more brokers (e.g., a retail broker and a wholesale broker) to engage in the database driven insurance application and approval process on behalf of that customer.

The system can be implemented as a method, an apparatus, a computer program product, a computer platform, and/or in a computing environment. Accordingly, the system includes hardware (e.g., at least one processor and a memory) and software (e.g., a customization engine) implemented as processor executable code that is stored on the memory. The customization engine of the system provides instructions for an overall process, invitation process, dynamic application building process, and authentication process. Thus, the system can be implemented by a combination of the processor executable code and the hardware, such that the customization engine is necessarily rooted in the operations of the at least one processor to improve or replace the conventional insurance software to further improve the speed and operation of the hardware. By way of example, the customization engine by executing on the at least one processor that is accessing the memory coupled thereto will increase speeds of the at least one processor, free processing power of the at least one processor, conserve memory use, and eliminate processor errors to make available computing resources and enable proper function of the hardware.

According to one or more embodiments, for example, the system uses a database to dynamically and automatically generate an electronic insurance application specific to a customer (e.g., a customer specific insurance application). The system processes the customer specific insurance application in real-time, and then again after the customer completes the customer specific insurance application. In this example, ‘real-time’ processing of the customer specific insurance application includes the customization engine processing inputs received within the customer specific insurance application while the customer specific insurance application is being completed by the customer and/or the retail broker. As part of the generating and processing of the customer specific insurance application, the system receives, manages, and processes non-standardized information (e.g., the inputs received within the customer specific insurance application) into a standardized format. Further, the system provides a completed customer specific insurance application as a customized insurance request that is used by the system to seek insurance from one or more insurance companies and that facilitates procurement of the insurance.

One or more advantages, technical effects, and/or benefits of the system (and the customization engine therein) include transforming and manipulating the non-standardized information into the customized insurance request, thereby enabling automatic insurance coverage that is otherwise is not currently available in or currently performed by conventional insurance software. Further, the system transforms and manipulates the non-standardized information into the customized insurance request in such a way as to conserve memory use and eliminate processor errors to make available computing resources and enable proper function of the hardware. Furthermore, the system improves information exchanges between all parties to the database driven insurance application and approval process by providing fidelity in the non-standardized information and efficiency in the exchange, which also conserve memory use and eliminate processor errors.

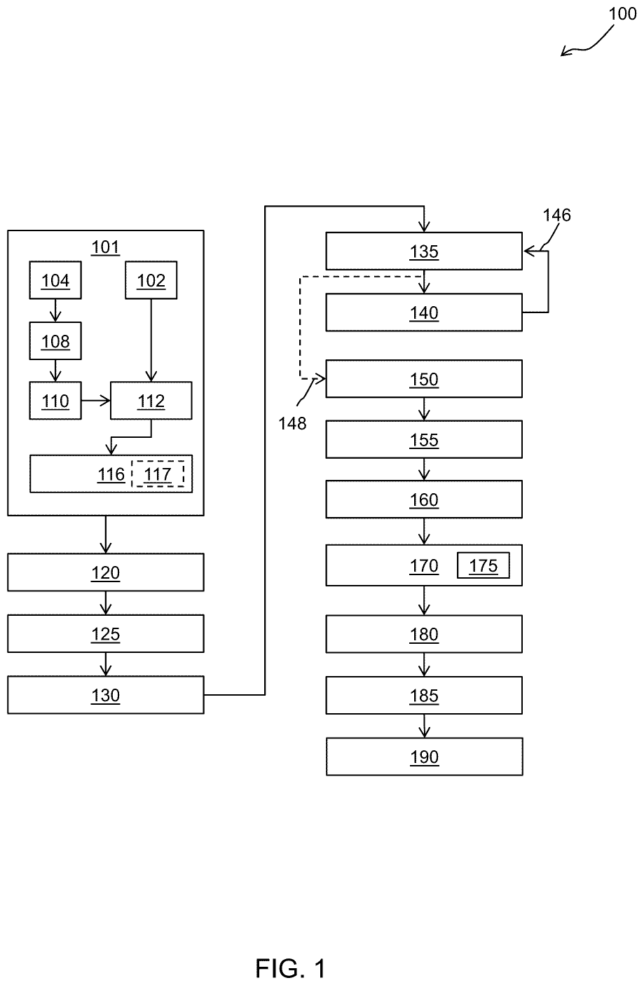

FIG. 1 illustrates a process 100 according to one or more embodiments. The process 100 is an example of an electronic insurance application workflow implemented by the system and components therein (e.g., the customization engine).

The process 100 begins at block 101, where the system generates a customer specific insurance application. The customer specific insurance application is specific to a user. The customization engine generates the customer specific insurance application from a dynamic insurance application template. The dynamic insurance application template is a shell form that is configurable by the customization engine. The customer specific insurance application is a dynamic insurance application template that has been modified and manipulated by the customization engine to be specific to a user. According to one or more embodiments, the system generates the dynamic insurance application template as described in the sub-blocks of block 101.

At sub-block 102, the customization engine generates an unfilled application for insurance coverage as the dynamic insurance application template. The system generates the unfilled application for insurance coverage for a first user. A first user can be a customer, such as an uninsured, underinsured, or insured consumer, as well as an entity or a business. The unfilled application for insurance coverage can be initially created by the customization engine at the direction of or input from a second user or a third user. The second user can be a retail broker or an agent that represents the first user. The third user can be a wholesale broker or an insurance company. The unfilled application for insurance coverage can also be a pre-existing insurance application form, which can be further modified by the system at the direction of and input from the second user. According to one or more embodiments, the customization engine receives a selection of the pre-existing insurance application form or version for the first user as provided by the second user. According to one or more embodiments, the unfilled application for insurance coverage can be a portable document format (PDF) document or word processing document of a generic insurance coverage application.

At sub-block 104, the system receives a unique identification. According to one or more embodiments, the unique identification can be an email address of the first user. The unique identification can include a social security number, a passport number, a driver's license number, or tax identification number of the first user. The unique identification can be provided by the first user or the second user though a user interface of the customization engine. According to one or more embodiments, the unique identification can be received in response to a query from the customization engine to the first user or the second user.

At sub-block 108, the system uses the unique identification to generate or establish a user account or identify a pre-existing user account for the first user. Generally, the system supports one or more user accounts for one or more users (e.g., first, second, and third users as described herein). Each user account of the one or more user accounts is unique and distinct to a user based on the unique identification.

At sub-block 110, the system generates a unique customer link and a pin. The link and the pin can be generated by the customization engine based on the unique identification, the user account, or both. The unique customer link can be a direct and unique uniform resource locator (URL) provided on a per user account basis (as identified or generated by the unique identification provided at sub-block 110). Further, the unique customer link can also be based on one or more of an agent identification (ID), a broker ID, and a pre-existing insurance application form or version (e.g., as related to the third user). The pin is a set quantity and ordinal combination of alpha-numeric characters. The pin can be a six (6) digit alpha-numeric key. The pin is utilized for authentication of the first user.

According to one or more embodiments, after the second user provides the unique identification, the customization engine automatically generates the unique customer link and the pin based on that unique identification. The direct and unique URL can be for the first user, for example, directly associated with or tied to the email address of the customer. The pin is utilized for authentication of the customer after the customer selects/clicks the unique customer link. The pin can also be user established and stored in the user account.

At sub-block 116, the system automatically generates the customer specific insurance application. For instance, the customization engine automatically generates the customer specific insurance application based on the unfilled application for insurance coverage, the user account associated with the email address, and non-standardized information in a non-standardized format within the user account and/or other sources.

The non-standardized information can include names, date of births, addresses, timestamps and/or dates, coverage limits, property for coverage, property descriptions, insurance type, etc. The non-standardized information can include information regarding specialized insurance needs, such as a description of what the customer does, a description of the activity being performed, a description of property use, etc., each of which can be adapted to a unique nature of a customized insurance request by the system.

The other sources can include, but are not limited to, databases of the system and third party databases (e.g., storing physician or address data). The customer specific insurance application can include one or more questions and corresponding empty answer fields, as well as independent interface elements for receiving information. The one or more of the empty fields can also be automatically populated by the system.

According to one or more embodiments, at optional dashed-block 117, the system automatically populates one or more empty answer fields of the customer specific insurance application based on data for the first user by grabbing/obtaining/using the non-standardized information (thereby manipulating the non-standardized information into a standardized format of the customer specific insurance application). For instance, the dynamic insurance application template can be a renewal application that is automatically populated by the customization engine using the non-standardized information from one or more existing insurance policies and applications associated with the user account. By way of example, the one or more existing insurance policies and applications can be from distinct and separate insurance companies that require/provide data in a unique way (e.g., a first insurance company can identify a number of claims using numbers, while a second insurance company can identify a number of claims using letter designations). The system can merge the separate non-standard numbers and letter designations to a standard value, when automatically populating a previous claim field of the dynamic insurance application template to generate the customer specific insurance application. Further, the customization engine can receive can receive a current application or other document (e.g., whether by scanning or receiving through email), process the current application or other documents, and manipulate any non-standardized information therein to automatically populate the one or more empty answer fields of the customer specific insurance application.

At block 120, the system sends an invite to the customer specific insurance application to the first user. The invite by the customization engine can be sent via a text message, an email, or the like. The invite includes the unique customer link to the customer specific insurance application within the system. The invite can be triggered by the second user. By way of example, the retail broker invites the customer to the system by causing the customization engine to send the unique customer link to the customer specific insurance application via a text message. The invite can also include the pin. According to one or more embodiments, the pin can be provided separately, such as by a second or subsequent invite.

The first user selects/clicks on the unique customer link of the invite. In response, at block 125, the system initiates access for the first user to the customer specific insurance application. The system initiates access by performing one or more authentication operations. The one or more authentication operations are a mechanism to securely identify any of the first, second, or third users accessing the system. The one or more authentication operations can be unique to each category (i.e., first, second, or third) of user. According to one or more embodiments, the customization engine performs one or more authentication operations by presenting the first user with a prompt, pop-up, or window for entering the pin.

In response to receiving the pin through the prompt, pop-up, or window, the process 100 continues to block 130, where the customization engine presents the customer specific insurance application to the first user. According to one or more embodiments, presentation of the customer specific insurance application can be performed by a software tool of the system that generates a customer friendly and specific user interface. The customer friendly and specific user interface can be presented by any display of a device via a web browser, a standalone application, a client portal shown, etc.

At block 135, the system receives one or more inputs from the first user. At block 140, the system dynamically modifies the customer specific insurance application. As shown by arrow 146, the system loops through blocks 135 and 140 until the customer specific insurance application is complete. Accordingly, the customization engine adapts the customer specific insurance application to the one or more inputs by adding one or more questions and one or more corresponding fields that solicit or bring on further inputs. The one or more questions and the one or more corresponding fields are requests for the additional information from the first user. The additional information includes, but is not limited to, specialized data relative to a unique nature of the customer specific insurance application. According to one or more embodiments, as the customization application dynamically builds the customer specific insurance application, the customization application can also proactively gather the additional information from databases of the system and third party databases. For instance, the customization application can interface with a physicians and surgeons database that stores publicly available additional information (e.g., like education, type of practice, and board actions) that can be gathered and manipulated by the customization application dynamically builds the customer specific insurance application. By being proactive in gathering and manipulating of the publicly available additional information, the customization application can shorten processing times for building the customer specific insurance application and release memory resources in view of completed customer specific insurance applications at a faster pace (e.g., since information is with the customization application sooner).

According to one or more embodiments, the customization engine dynamically modifies and builds the customer specific insurance application from a corpus of insurance information stored in the system (i.e., the customer specific insurance application is a database driven) as the first user is completing the application. In this regard, as the first user provides inputs to fields and/or answers to questions, the customization engine generates additional fields or questions to proactively gather additional information from the first user. Thus, the customization engine is configured to ask question sets that only pertain to special insurance needs of the first user. For instance, the customization engine can distinguish between an individual distributor or a distribution center for pharmaceuticals and distinguish between business residencies. By way of example, different question sets are generated as the customization engine determines in real time whether the distributor is an individual or a center, whether the pharmaceuticals is psylocibin or morphine, and whether the distributor is in Pennsylvania or Washington, the customization engine can present different question sets related to the special insurance needs to further modify and dynamically build the customer specific insurance application. By identifying the special insurance needs in real time through the different question sets, the customization application can shorten processing times for building the customer specific insurance application and reduce a number of additional static forms and appendixes required from an insurance request (e.g., since information is with the customization application sooner).

Note that processor speed is gained and memory conserved because the customization engine executes by efficiently looping through blocks 135 and 140 in a dynamic manner to ascertains special insurance needs of the first user. Without the process 100, conventional insurance software would continue to be a serial form process that over long amounts of time accumulates/generates duplicate documentation with multiple appendix forms as user circumstances increase in complexity, which occupies memory and bogs down computing systems. Further, because of the complexity of user circumstances (e.g., applicable state laws, categories of insurance, particular insurance needs to specific liability scenarios, etc.), a human could not process by hand or within their mind the dynamically modification of the customer specific insurance application as performed by the customization engine.

Once the customer specific insurance application is complete, the process 100 exits the loop of blocks 135 and 140 and proceeds to block 150 as shown by the dashed-arrow 148. In this regard, the dashed-arrow 148 is representative of an automatic determination by the system that all information required from the first user (in combination with the gathered information from databases of the system and third party databases) has been acquired.

Thus, the system can be implemented by a combination of the processor executable code and the hardware, such that the customization engine is necessarily rooted in the operations of the at least one processor to improve or replace the conventional insurance software to further improve the speed and operation of the hardware. By way of example, the customization engine by executing on the at least one processor that is accessing the memory coupled thereto will increase speeds of the at least one processor, free processing power of the at least one processor, conserve memory use, and eliminate processor errors to make available computing resources and enable proper function of the hardware

For example, because the customization engine facilitates procurement of insurance from the third user on behalf of the first user, the customization engine determines when the customer specific insurance application includes enough information to provide a completed customer specific insurance application as a customized insurance request to the third user.

At block 150, the system processes the one or more coverage characteristics to produce a submission of a customized insurance request on behalf of the first user. The submission can be a one-time or single instance submission, and the customized insurance request is particular to the first user based on the process 100 of generating the request. The customized insurance request identifies the one or more coverage characteristics in a standardized form that any third user can process. Note that a technical effect and benefit of the customization engine is that the customized insurance request provides fidelity to the special insurance needs of the first user within the standardized form. In this regard, the customization engine determines one or more coverage characteristics for insuring the first user from the completed customer specific insurance application. The one or more coverage characteristics are packaged within a customized insurance request that is associated with the completed customer specific insurance application. Examples of the one or more coverage characteristics include, but are not limited to, whether or not a physician prescribes opioids, whether the physician is an individual or a part of a practice group, and which state the physician is located.

One or more advantages, technical effects, and/or benefits of the system include automatically presenting and completing the customer specific insurance application via the customer friendly and specific user interface so that the customized insurance request is a one-time submission to the third user, thereby avoiding multiple time-consuming rounds customer/broker/insurance company communications, providing fidelity in the non-standardized information, efficiency in information exchange, conserving memory use, and eliminating processor errors.

At block 155, the system stores the customized insurance request and completed customer specific insurance application. The customized insurance request and completed customer specific insurance application can be stored by the system as a document portfolio associated with the user account of the first user. The document portfolio is at least a collection of completed forms, applications, and requests related to a user and available for use by the customization engine.

At block 160, the system stores all non-standardized and standardized data (“data” generally) collected throughout the process 100. In this regard, the customization engine can continuously perform data collection operations to aggregate the data of the process 100 for use in subsequent iteration thereof. The data can include, but is not limited to, a corpus of insurance information, inputs to fields, or answers to questions, standardized and non-standardized information (e.g., names, date of births, addresses, timestamps and/or dates, coverage limits, property being coverage, property descriptions, insurance type, information regarding specialized insurance needs, description of what the customer does, description of the activity being performed, a description of property use), submissions, insurance applications, insurance requests, notifications, and other data described herein (e.g., the document portfolio). Notifications can include, but are not limited to, emails, texts, pop-ups, badges, banners, and other mechanisms that provide information to a user. Notifications can be implemented by push or pull operations of the customization engine.

At block 170, the system provides the customized insurance request to the third user. The request can be provided automatically. The customized insurance request can be a field or line in an insurance company specific user interface that includes links to the one or more coverage characteristics and the one or more coverage characteristics. The customized insurance request can be a PDF document or a word processing document.

According to one or more embodiments, the customization engine can provide the customized insurance request by enabling electronic access for the third user to the stored document portfolio. The customization engine can provide the customized insurance request by transmitting, to the third user, the stored document portfolio. In the case where the third user is the insurance company, the customization engine provides the customized insurance request directly. In the case where the third user is the wholesale broker, the process 100 can include a sub-block 175. At sub-block 175, the wholesale broker provides the customized insurance request to a plurality or marketplace of insurance companies to solicit a response. Note that access to the system by the second and third users can be similar, though not identical, to access to the system by the first user. In this regard, the second and third users have unique interfaces, links, pins, authentications, and user interfaces that are particular to the type of access and use required by the second and third users.

At block 180, the system receives a response from the third user. The response can include where the third user can deny, approve, or counter the customized insurance request. If the third user counters the customized insurance request, the customized insurance request can return to earlier in the process 100 (e.g., block 125) where the first user is further engaged to answer additional questions sets or provide additional information. If the third user denies the customized insurance request, the process 100 ends. Note that a notification can be sent in response to the denial to the first user from the system. If the third user approves the customized insurance request, the process 100 proceeds to block 185.

At block 185, the system notifies the first user of approval and facilitates payment transfers between the first user and the third user. As described herein, notifications can include, but are not limited to, emails, texts, pop-ups, badges, banners, and other mechanisms that provide information to a user.

At block 190, the system provides automatic insurance coverage to the first user. The system can provide the automatic insurance coverage to the first user by generating and providing documentation. The documentation can include proof of coverage for the first user based on all submissions. The system can provide the documentation by enabling electronic access for the first user to the documentation. The system can provide the documentation by transmitting to the first user to the documentation.

The system includes processor executable code or software (e.g., the customization engine) that is necessarily rooted in process operations by processing hardware. In turn, the processing hardware and the system execute process operations of the process 100. These process operations can happen in alternative combinations, orders, and iterations to at least receive submissions, dynamically build applications, process non-standardized information into a standardized format, automatically generate documentation based on stored submissions, transmitting notifications and documentation to all of the users, etc. Note that the system can include machine learning and/or artificial intelligence (“ML/AI”), models, neural networks, optical character recognition, security keys, non-fungible tokens, and other computer process operations.

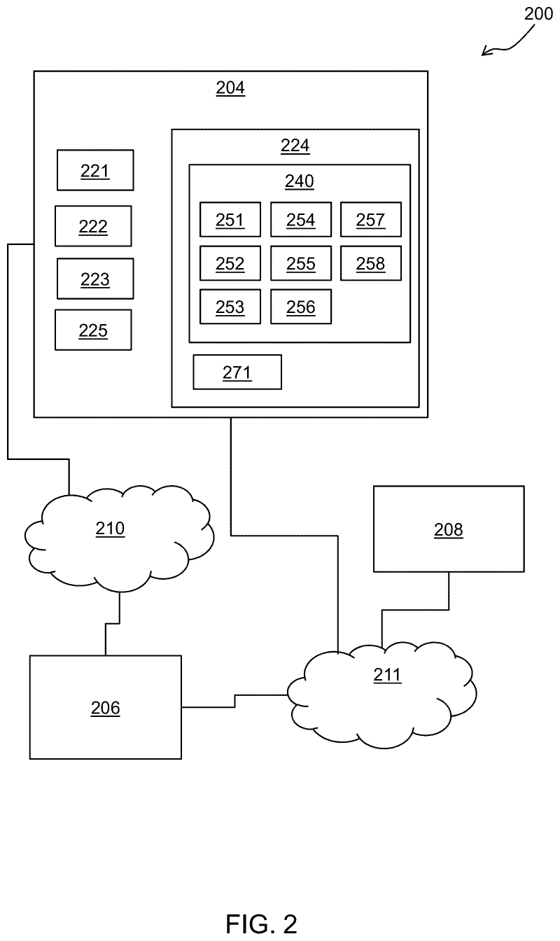

Turning now to FIG. 2, a diagram of a system 200 in which one or more features of the disclosure subject matter can be implemented is illustrated according to one or more exemplary embodiments. The system 200 includes a device 204, a first computing device 206, a second computing system 208, a first network 210, and a second network 211. Further, the device 204 can include an output component 221, a processor 222, a user input (UI) sensor 223, a memory 224, and a transceiver 225. The system 200 includes a customization engine 240, which is an example of processor executable code or software of the system described herein.

Accordingly, the device 204, the first computing device 206, and/or the second computing system 208 can be programed to execute computer instructions with respect the customization engine 240. As an example, the memory 223 stores these instructions for execution by the processor 222 so that the device 204 can receive and process the input via the user input (UI) sensor 223. Note that the processor 222 and the memory 223 are representative of processors and memories of the first computing device 206 and/or the second computing system 208.

The device 204, the first computing device 206, and/or the second computing system 208 can be any combination of software and/or hardware that individually or collectively store, execute, and implement the customization engine 240, and functions thereof. Further, the device 204, the first computing device 206, and/or the second computing system 208 can be an electronic, computer framework comprising and/or employing any number and combination of computing device and networks utilizing various communication technologies, as described herein. The device 204, the first computing device 206, and/or the second computing system 208 can be easily scalable, extensible, and modular, with the ability to change to different services or reconfigure some features independently of others.

The networks 210 and 211 can be a wired network, a wireless network, or include one or more wired and wireless networks. According to an embodiment, the network 210 is an example of a short-range network (e.g., local area network (LAN), or personal area network (PAN)). Information can be sent, via the network 210, between the device 204 and the first computing device 206 using any one of various short-range wireless communication protocols, such as Bluetooth, Wi-Fi, Zigbee, Z-Wave, near field communications (NFC), ultra-band, Zigbee, or infrared (IR). Further, the network 211 is an example of one or more of an Intranet, a local area network (LAN), a wide area network (WAN), a metropolitan area network (MAN), a direct connection or series of connections, a cellular telephone network, or any other network or medium capable of facilitating communication between the first computing device 206 and the second computing system 208. Information can be sent, via the network 211, using any one of various long-range wireless communication protocols (e.g., TCP/IP, HTTP, 3G, 4G/LTE, or 4G/New Radio). Note that for either network 210 and 211 wired connections can be implemented using Ethernet, Universal Serial Bus (USB), RJ-11 or any other wired connection and wireless connections can be implemented using Wi-Fi, WiMAX, and Bluetooth, infrared, cellular networks, satellite or any other wireless connection methodology.

In operation, the device 204 can obtain, monitor, store, process, and communicate via network 210 inputs, information, and outputs. Further, the device 204, the first computing device 206, and/or the second computing system 208 are in communication through the networks 210 and 211 (e.g., the first computing device 206 can be configured as a gateway between the device 204 and the second computing system 208). For instance, the device 204 can be an example of the system 100 of FIG. 1 configured to communicate with the first computing device 206 via the network 210. The first computing device 206 can be, for example, a stationary/standalone device, a base station, a desktop/laptop computer, a smart phone, a smartwatch, a tablet, or other local device configured to communicate with other devices via networks 211 and 210. The second computing system 208, implemented as a physical server on or connected to the network 211, as a virtual server in a distributed computing environment of the network 211, or other remote devices, can be configured to communicate with the first computing device 206 via the network 211. Thus, the inputs, the information, and the outputs can be communicated throughout the system 200.

The processor 222, in executing the customization engine 240, can be configured to receive, process, and manage the inputs acquired by the UI sensor 223, and communicate the inputs to the memory 224 for storage and/or across the network 210 via the transceiver 225. The inputs from one or more other apparatuses can also be received by the processor 222 through the transceiver 225.

According to one or more embodiments, the customization engine 240 can include one or more application programming interfaces (APIs), user interfaces (including customer friendly and specific user interfaces), or like endpoints, such as an agent portal 251, an underwriting workbench 252, a customer relationship management (CRM) component 253, a document creation and customer communication management (CCM) component 254, a workflow/business process management (BPM) component 255, a business intelligence (BI) analytics and reporting component 256, specialized components 257, and a customer portal 258.

For example, the agent portal 251 can be a broker specific user interface for the second users. The agent portal 251 can enable customer specific insurance application creation, editing, and submission. The agent portal 251 can include enabling authentication of the second user. The agent portal 251 can include entering a new business application and submitting the customized insurance request to the third user for issuance. The agent portal 251 can enable document generation. Document generation can include an ability to render proposal documents or integrate with document creation tools provided by the agent portal 251.

Further, the underwriting workbench 252 can be insurance company specific user interface for the third users. The underwriting workbench 252 can enable customer specific insurance application submission, receipt, and processing. The underwriting workbench 252 can include enabling authentication of the third user. For example, the underwriting workbench 252 can include submitting the customized insurance request via paper, email, or web to an underwriter for review. The underwriting workbench 252 can enable renewal processing. The renewal processing can include automatically pulling policies before an effective date for renewal or routing policies to an underwriter for review. The underwriting workbench 252 can enable third-party data integration. The third-party data integration can include automatically ordering third-party data based on specific risk characteristics at time of quotation or issuance.

The CRM component 253 can provide reporting and analytics, which include performing analytics on account activity data to understand opportunities for sales, marketing, and customer service.

The document creation and CCM component 254 can provide document authoring, which includes native tools (e.g., word processing or proprietary tools) for composition and design. The document creation and CCM component 254 can provide a rendering engine that supports retrieving, processing, and updating data from external sources to create reports and produce data files for new applications.

The workflow/BPM component 255 can provide integration, such that the system can integrate with other systems like underwriting, claims, and customer service to pull data and feed transactions.

The analytics and reporting component 256 can include ad hoc reporting, such that the system can access data for reporting at run-time.

The specialized components 257 can provide enterprise e-Signature abilities, where data in electronic form is attached to or logically associated with other data in electronic form and which is used by a signatory to sign.

The customer portal 258 (e.g., customer friendly and specific user interface for the first users) can enable customer specific insurance application creation, editing, and submission. For example, the customer portal 258 can include enabling authentication of the first user and completing a customer specific insurance application by the first user.

The customization engine 240 can also include a customer portal, a rating engine, a distribution compensation management component, a policy administration system, a billing component, a reinsurance management component, a claims system, an enterprise content management (ECM) component, and other repositories.

The output component 221 includes and is representative of, for example, any device, transducer, speaker, touch screen, and/or indicator configured to provide outputs by audio, video, touching, etc. The output component 221 may include, for example, a speaker configured to convert one or more electrical signals into audible sounds.

The UI sensor 223 includes and is representative of, for example, any device, transducer, touch screen, and/or sensor configured to receive a user input by audio, video, touching, etc. The UI sensor 223 may include, for example, one or more transducers configured to convert one or more environmental conditions into an electrical signal, such that different types of audio are observed/obtained/acquired. The UI sensor 223 may include, for example, a touch screen interface integrated into a display (e.g., the output component 221).

The memory 224 is any non-transitory tangible media, such as magnetic, optical, or electronic memory (e.g., any suitable volatile and/or non-volatile memory, such as random-access memory or a hard disk drive). The memory 224 stores the computer instructions for execution by the processor 222. The memory 224 stores data 271, which is representative of submissions, responses, insurance requests, non-standardized information, specialize data, renewal information, additional information, corpus of insurance information, completed applications, user information, pins, user accounts, email addresses, social security numbers, personal identifiable information, other non-standardized and standardized data collected throughout the dynamic electronic insurance application workflow and/or the database driven insurance application and approval process, and the like described herein.

The transceiver 225 may include a separate transmitter and a separate receiver. Alternatively, the transceiver 225 may include a transmitter and receiver integrated into a single device. The transceiver 225 enables communication with other software and components of the system 200.

In operation, the system 200, utilizing the customization engine 240 and other software and components therein, generates information responsive to a input and provides an output. For example, the device 204 utilizes the memory 224, and shares portions and/or all information across the system 200 via the transceiver 225 to implement the operations of the system. The operations of the system 200, such as the operations of the customization engine 240, can includes utilizing models, neural networks, and/or ML/AI that generate information based on a input and generate an output from the information.

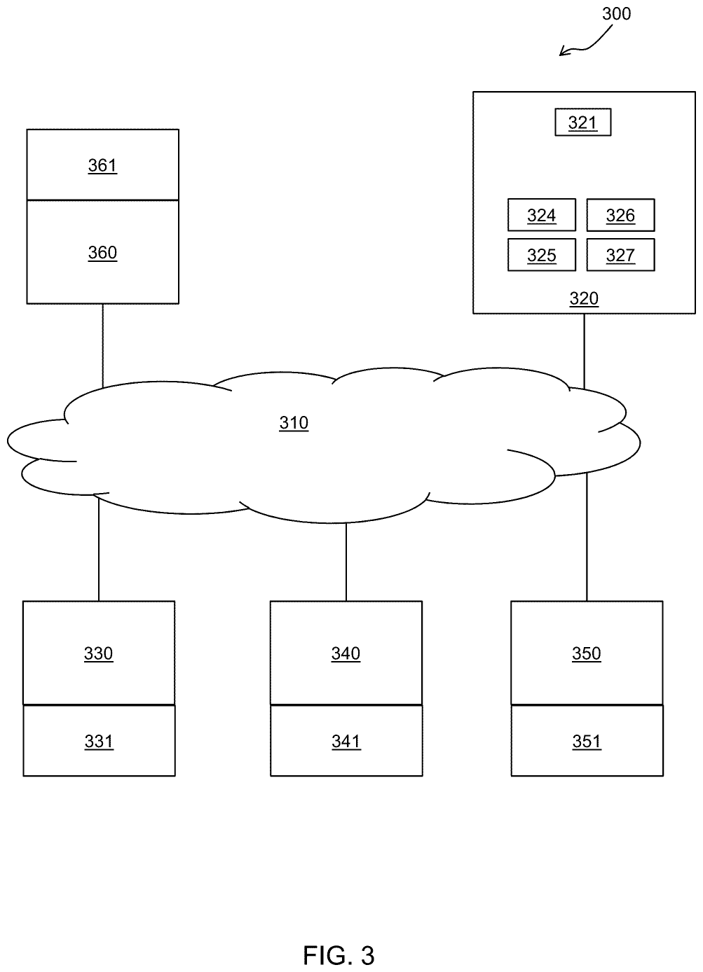

FIG. 3 depicts a diagram of an environment 300 according to one or more exemplary embodiments. The environment 300 includes a network 310 and a customization engine 320. The customization engine 320 is an example implementation of the customization engine 240 of FIG. 2 which is an example of processor executable code or software of the system described herein. The customization engine 320 includes a software tool 321 and provides one or more authentication operations 324, 325, 326, and 327. The one or more authentication operations 324, 325, 326, and 327 may be performed in any order.

The environment 300 includes a user system 330 by which a customer 331 (e.g., a first user) accesses the customization engine 320, a broker system 340 by which a retail broker 341 (e.g., a second user) accesses the customization engine 320, a wholesale broker system 350 by which a wholesale broker 351 (e.g., a third user) accesses the customization engine 320, and a company system 360 by which an insurance company 361 (e.g., a third user, such as an employee thereof) accesses the customization engine 320.

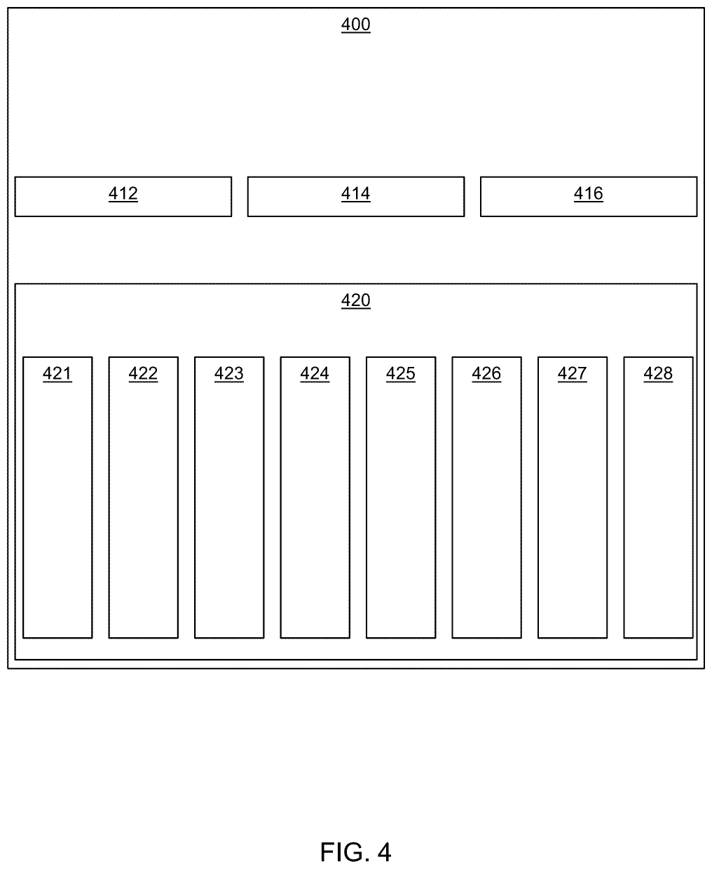

FIG. 3 is described with respect to FIGS. 4-14, which depict user interfaces according to one or more exemplary embodiments. Generally, the user interfaces of FIGS. 4-14 are generated by the customization engine 320 and presented by a display (e.g., the output component 221 of FIG. 2) a corresponding system 330, 340, 350, and 360 for the first and second users. The first and second users can engage the user interfaces of FIGS. 4-14 to enable the dynamic electronic insurance application workflow and the database driven insurance application and approval process by the environment 300.

According to one or more embodiments, the customization engine 320 and the systems 330, 340, 350, and 360 can be any computing system (e.g., the device 204, the first computing device 206, and/or the second computing system 208) and include any hardware and software as needed to execute the one or more authentication operations 324, 325, and 326. The customization engine 320 is an example of the system implemented as a server and the software tool 321 is an example of the client application or web-based tool, as described herein. The customization engine 320 and the software tool 321 can connect and communicate via the network 310 to the systems 330, 340, 350, and 360 as needed to execute the one or more authentication operations 324, 325, and 326. The systems 330, 340, 350, and 360 can connect and communicate to the customization engine 320 and the software tool 321 as needed to execute the one or more authentication operations 324, 325, and 326 (e.g., the systems 330, 340, 350, and 360 access the customization engine 320 using a web browser that load a user interface of the software tool 321). The systems 330, 340, 350, and 360 can optionally include client instances of the software tool 320, or independent instances, as needed to execute the one or more authentication operations 324, 325, and 326. Thus, the environment 300 contemplates implementing web-server, client-server, local processing and/or like models. Each of the customer 331, the retail broker 341, the wholesale broker 351, and the insurance company 361 can be representative of one or more users interacting with the environment 300.

The customization engine 320 provides the software tool 321 as a software/hardware workflow tool that automates one or more portions of a database driven insurance application and approval process (e.g., for the customer 331 seeking insurance from the insurance company 361, where the retail broker 341 and the wholesale broker 351 engage therein). The database driven insurance application and approval process (e.g., the one or more authentication operations 324, 325, and 326) can include, but is not limited to authentication operations, generating and populating documents, creating confirmations, collecting and storing insurance information, generating instructions, document management, and sending notifications to participants.

The customization engine 320 and/or the software tool 321 provides authentication operations across one or more layers (e.g., four (4) layers, each identified by authentication operations 324, 325, 326, and 327), where each of the one or more layers can have different authentication methods and levels. A first layer can include an insurance carrier layer as authentication operation 324. A second layer can include a wholesale broker layer as authentication operation 325. A third layer can include a retail agent layer as authentication operation 326. A fourth layer can include an insurance applicant layer as authentication operation 327.

The authentication operation 324 includes when the insurance carrier authenticates locally on the network 310 utilizing a local mechanism, such as Windows Credentials. The customization engine 320 will utilize the authentication operation 324 to grant privileges within the software tool 321. Any users authenticated by the authentication operation 324 can be considered “Fully Authenticated.”

The authentication operation 325 includes when the wholesale broker authenticates. According to one or more embodiments of the authentication operation 325, the wholesale broker can authenticate using an active directory federation service, such as through a portal (e.g., WSO2 portal). The active directory federation service allows the insurance carrier to manage access and serves as a secure authentication method for a user with elevated privileges. Any users authenticated by the authentication operation 325 can be considered “Fully Authenticated.”

Turning to FIGS. 4-7, a plurality of user interfaces are depicted according to one or more exemplary embodiments.

FIG. 4 depicts a user interface 400 according to one or more exemplary embodiments. The user interface 400 depicts a user interface provided to the third user (e.g., the wholesale broker or the insurance company) to view all active submissions for all associated second users. The user interface 400 depicts includes three tabs 412, 414, and 416, corresponding to retailers, applications, and existing applications. Further, the user interface 400 presents a table 420 including one or more columns 421, 422, 423, 424, 425, 426, 427, and 428, corresponding to company, retailer, application, insured, created date, expiration date, status (e.g., processing, new, approved, expired, rejected), and actions. Additional columns can be provided for the table 420. The column 428 can further include icons related to each action available to the third user or a link to a dropdown menu provide additional links to the actions available. From the user interface 400, the third user can copy URLs of active applications, view completed applications, and submit the application to an associated insurance carrier, as well as filter the table 420 to view expired applications, scroll or page through multiple rows of the table 420, and initiate further actions from the action column 428. An example application can include, but is not limited to, physicians and surgeons professional liability application.

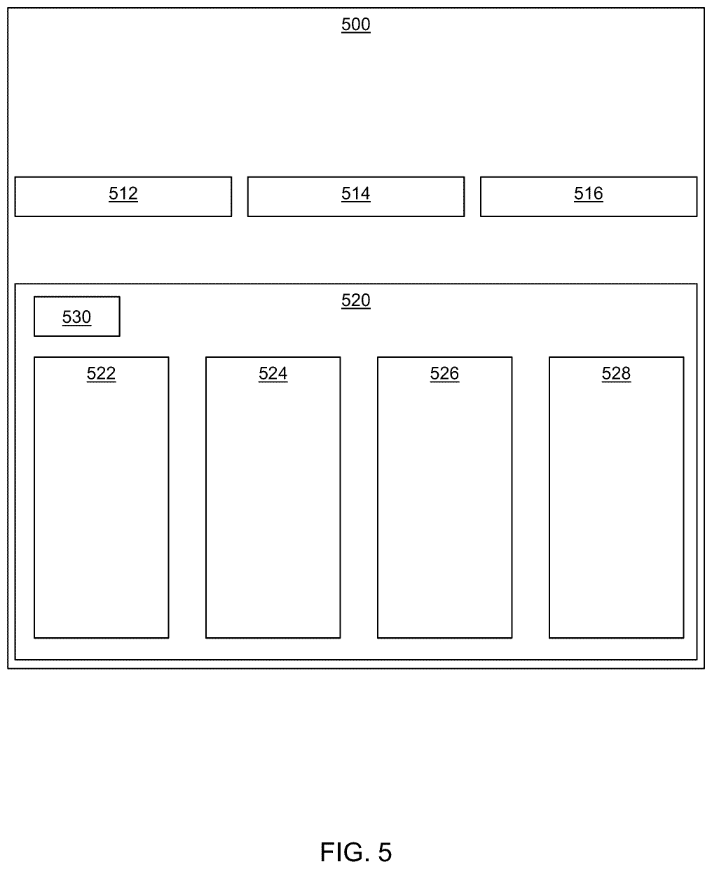

FIG. 5 depicts a user interface 500 according to one or more exemplary embodiments. The user interface 500 depicts a user management user interface provided to the third user (e.g., the wholesale broker or the insurance company) for the third user to manage relationships with the second users within the environment 300. The user interface 500 depicts includes three tabs 512, 514, and 516, corresponding to retailers, applications, and existing applications. Further, the user interface 500 presents a table 520 including one or more columns 522, 524, 526, and 528, corresponding to name, email, application, and actions. Additional columns can be provided for the table 520. The column 528 can further include icons related to each action available to the third user or a link to a dropdown menu provide additional links to the actions available. From the user interface 500, the third user can add second users using the add icon 530 and/or edit and delete the second users via the column 528.

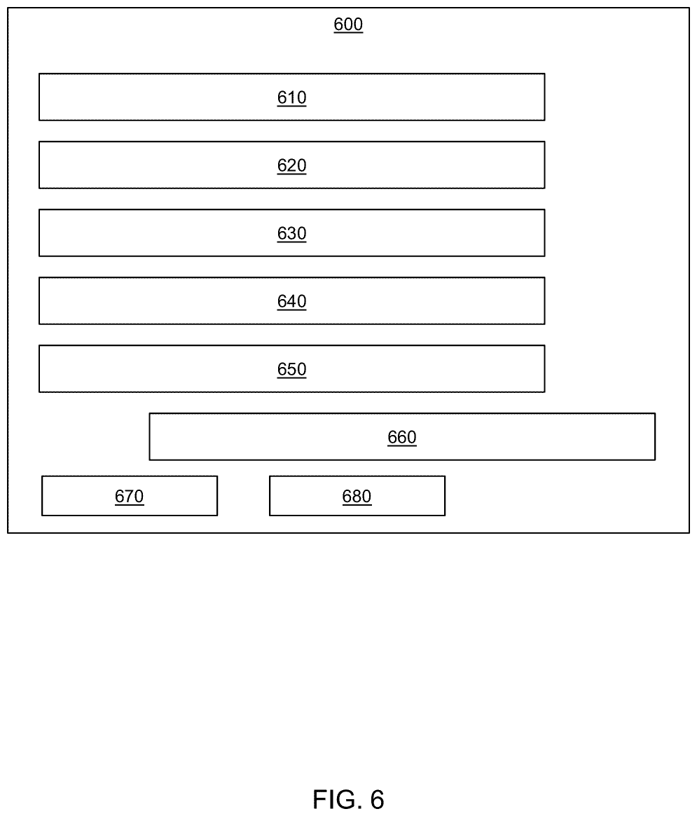

FIG. 6 depicts a user interface 600 according to one or more exemplary embodiments. The user interface 600 depicts add functionality provided to the third users for managing the second users. The user interface 600 can be a pop-up over the user interface 500 and can be triggered by a selection of the add icon 530 of FIG. 5. The user interface 600 includes a first name first 610, a middle name field 620, a last name field 630, a email address field 640, a phone number filed 650, an application field 660 (for identifying one or more applications for the second user), a cancel icon 670, and a create user icon 680. Note that a similar interface can be generated for edit functionality of a particular second user by a selection of an icon or a link within the column 528 for that particular second user.

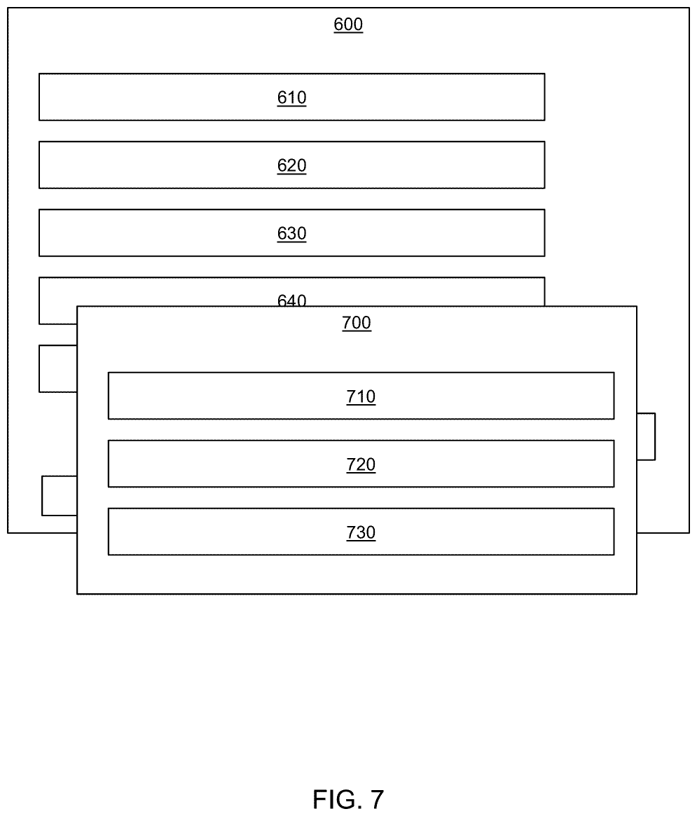

FIG. 7 depicts a user interface 700 according to one or more exemplary embodiments. The user interface 700 depicts insurance application association functionality provided to the third user. The user interface 700 can be a pop-up over the user interface 600 and can be triggered by a selection of the application field 660 of FIG. 6. The user interface 700 allows the third user to choose which second user works with which insurance application. In this regard, the user interface 700 presents a select all option 710 and one or more applications for the second user (represented by applications 720 and 730).

Returning to FIG. 3, the authentication operation 326 includes when the second user authenticates using a combination of unique URL and six (6) digit alpha-numeric pin. Both the unique URL and pin can be provided to the second user at a time of creation by the system. Any users authenticated by the authentication operation 326 are not considered “Fully Authenticated” and cannot view personal identifiable information.

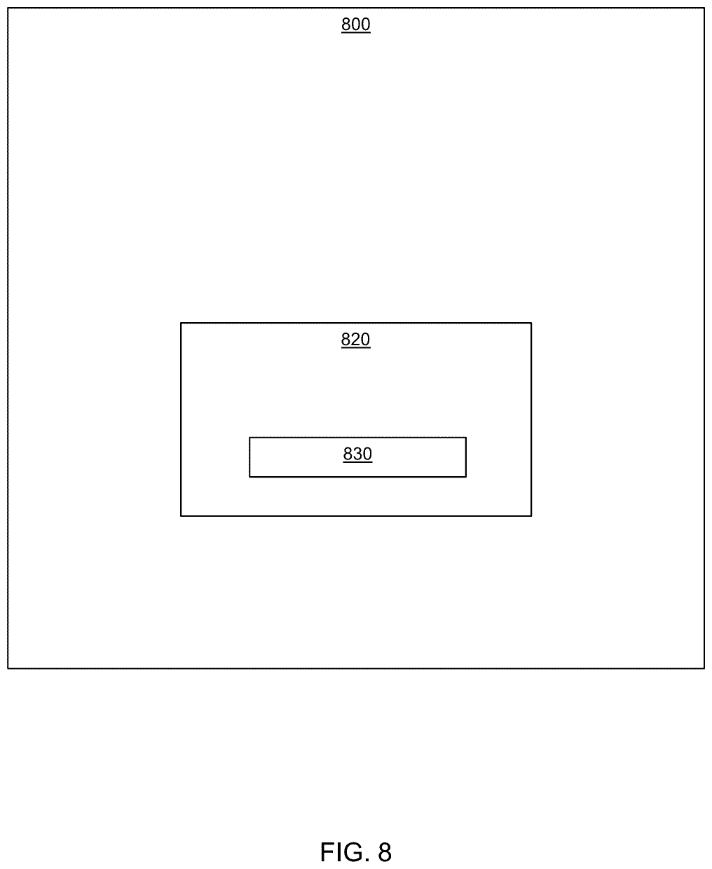

Turning to FIGS. 8-11, a plurality of user interfaces are depicted according to one or more exemplary embodiments.

FIG. 8 depicts a user interface 800 according to one or more exemplary embodiments. The user interface 800 depicts a login screen 820 with a field 830 for the second user. The login screen 820 can be provided overtop of the user interface 800, which can be a grayed out version of a landing page. For example, the second user is provided a unique URL and prompted to enter a six (6) digit alpha-numeric pin in the field 830.

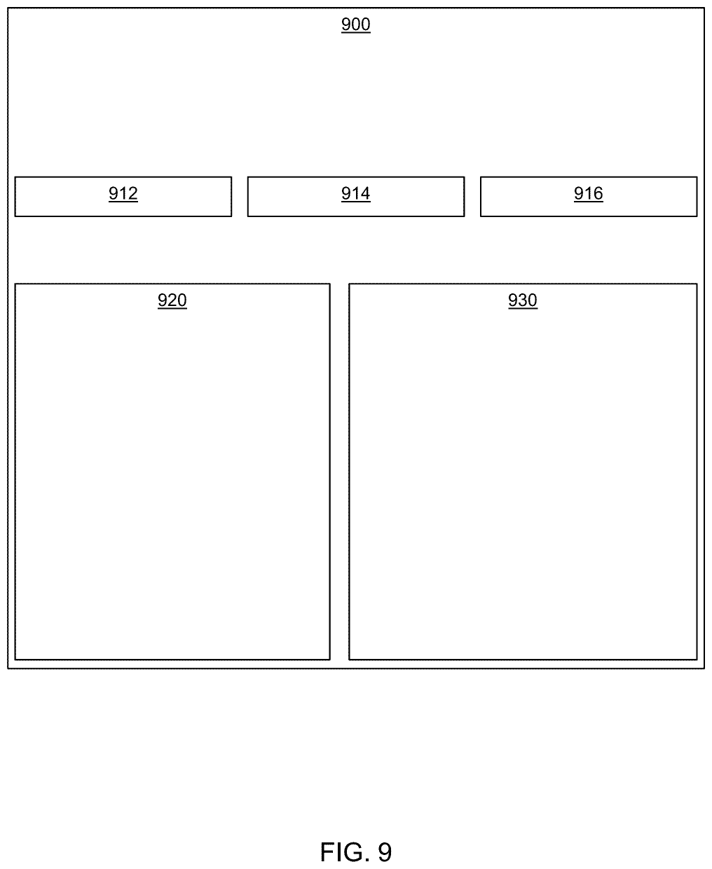

FIG. 9 depicts a user interface 900 according to one or more exemplary embodiments. The user interface 900 depicts a user interface provided to the second user (e.g., the retail broker or the agent) as a landing page. The user interface 900 depicts includes three tabs 912, 914, and 916, corresponding to wholesaler information, email applications, and existing applications. For example, in the user interface 900, a sub-frame 920 provides detail about an associated third user (e.g., a wholesale broker) and a sub-frame 930 provides detail about which insurance applications are available.

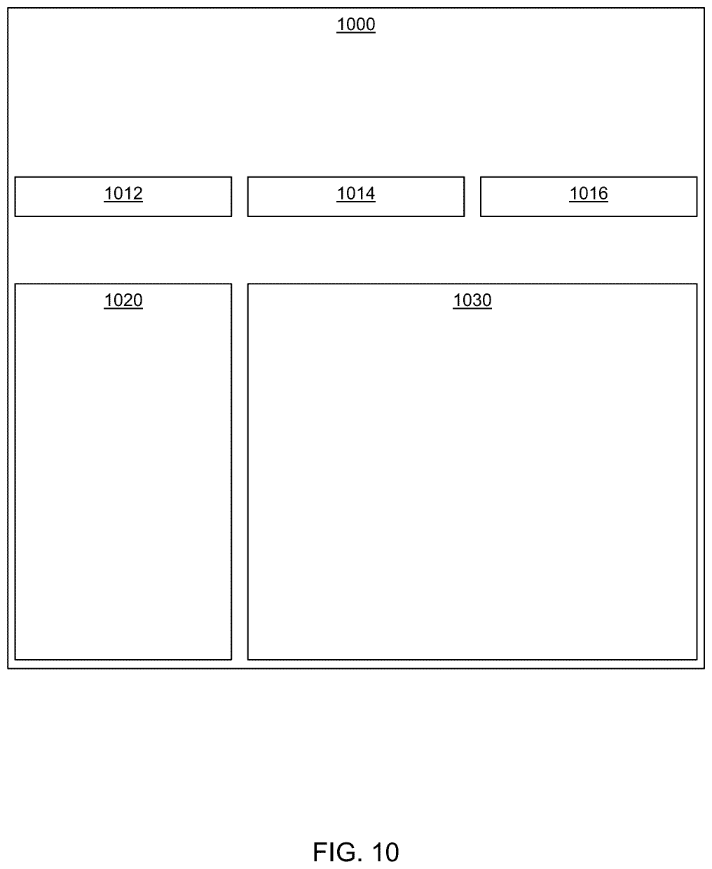

FIG. 10 depicts a user interface 1000 according to one or more exemplary embodiments. The user interface 1000 depicts includes three tabs 1012, 1014, and 1016, corresponding to wholesaler information, email applications, and existing applications. Further, the user interface 1000 depicts a user interface provided to the second user (e.g., the retail broker or the agent) where the second user can enter one or more unique identifications of first users (e.g., insurance applicant's email addresses) to invite the first users to complete a customer specific insurance application electronically. For example, in the user interface 1000, a sub-frame 1020 enables receipt of details for a dynamic insurance application template to generate a customer specific insurance application and a sub-frame 1030 enables receipt of details for which first users will use this dynamic insurance application template to dynamically build the customer specific insurance application. The first users, in turn, can receive from the customization engine an email with a link.

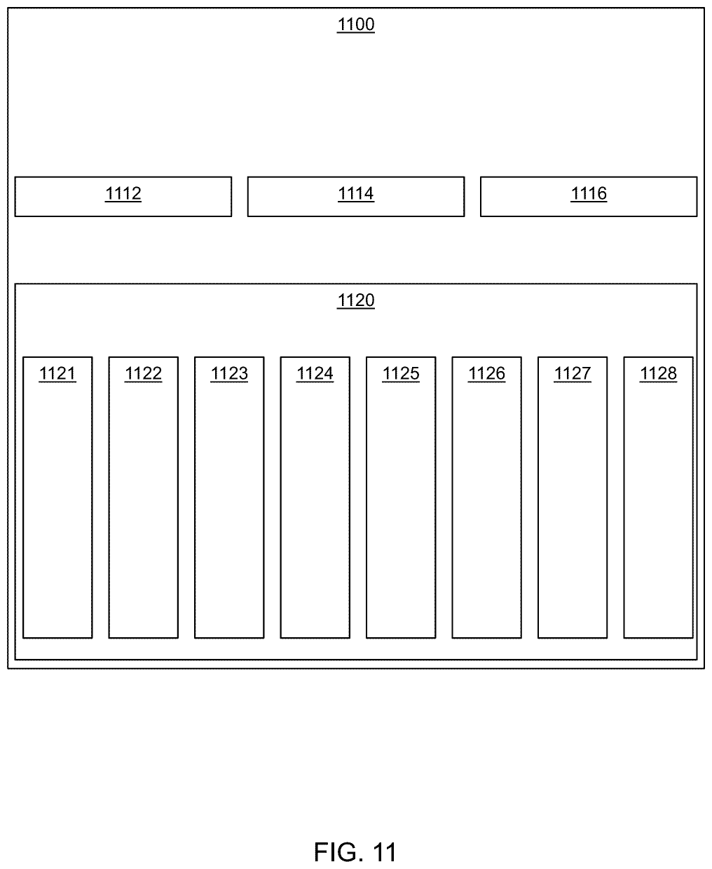

FIG. 11 depicts a user interface 1100 according to one or more exemplary embodiments. The user interface 1100 depicts a user interface provided to the second user (e.g., the retail broker or the agent) to view all active insurance applications for the first users. The user interface 1100 depicts includes three tabs 1112, 1114, and 1116, corresponding to wholesaler information, email applications, and existing applications. Within the user interface 1100, the second user has the capability of opening existing applications, viewing completed applications, or copying the URL to provide back to the first users. Further, the user interface 1100 presents a table 1120 including one or more columns 1121, 1122, 1123, 1124, 1125, 1126, 1127, and 1128, corresponding to company, wholesaler, application, insured, created date, expiration date, status (e.g., processing, new, approved, expired, rejected), and actions. Additional columns can be provided for the table 1120. The column 1128 can further include icons related to each action available to the second user or a link to a dropdown menu provide additional links to the actions available.

Returning to FIG. 3, the authentication operation 327 includes when the first user will authenticate using a combination of unique URL and email address. The URL is provided to the first user at time of creation. Any users authenticated by the authentication operation 327 are not considered “Fully Authenticated” and cannot view personal identifiable information.

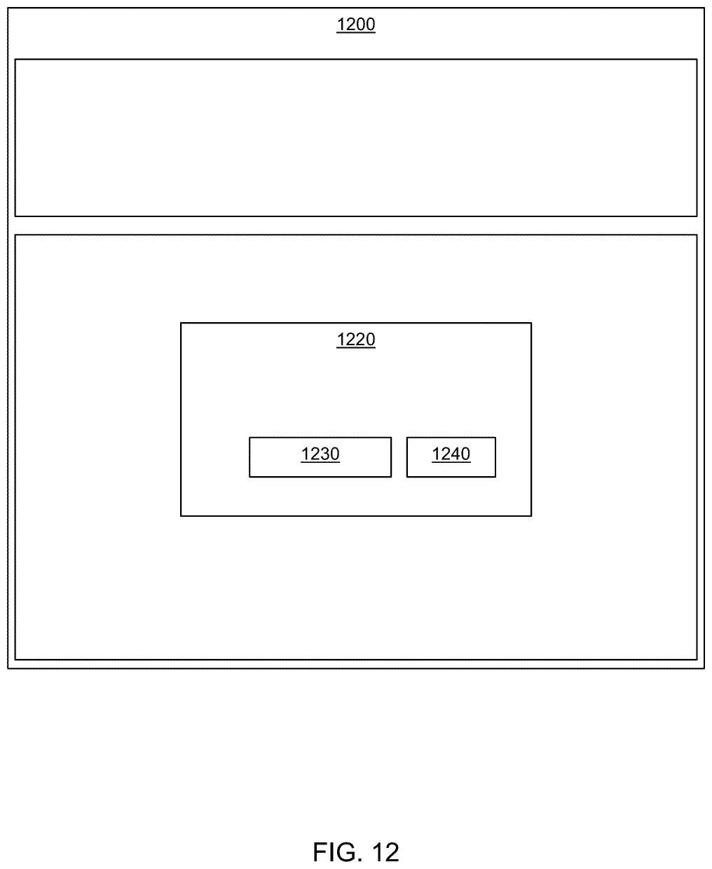

Turning to FIGS. 12-14, a plurality of user interfaces (e.g., one or more customer friendly and specific user interfaces) are depicted according to one or more exemplary embodiments.

FIG. 12 depicts a user interface 1200 according to one or more exemplary embodiments. The user interface 1200 depicts a login screen 1200 with a field 1230 and a login icon 1240 for the first user. The first user access the user interface 1200 based on a unique URL provided to the first user. The field 1230 can receive an email address. Entering the email address by the first user into the field 1230 and selecting the login icon 1240 can authenticate or initiate the authentication of the first user.

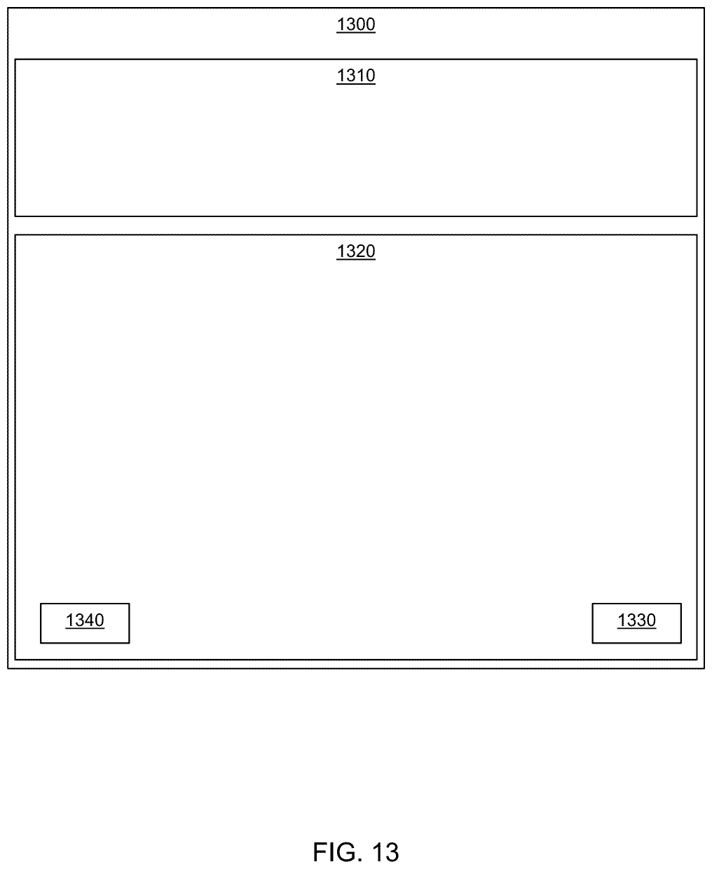

FIG. 13 depicts a user interface 1300 according to one or more exemplary embodiments. The user interface 1300 depicts a landing page introducing a customer specific insurance application with a banner message in a first frame 1310 and a welcome message in a second frame 1320. The banner message can indicate a title of the customer specific insurance application (e.g., a ‘physicians and surgeons professional liability application’). The welcome message can detail in plane language how the first user can proceed. A next icon 1330 can advance the customer specific insurance application. A exit icon 1340 can close the customer specific insurance application.

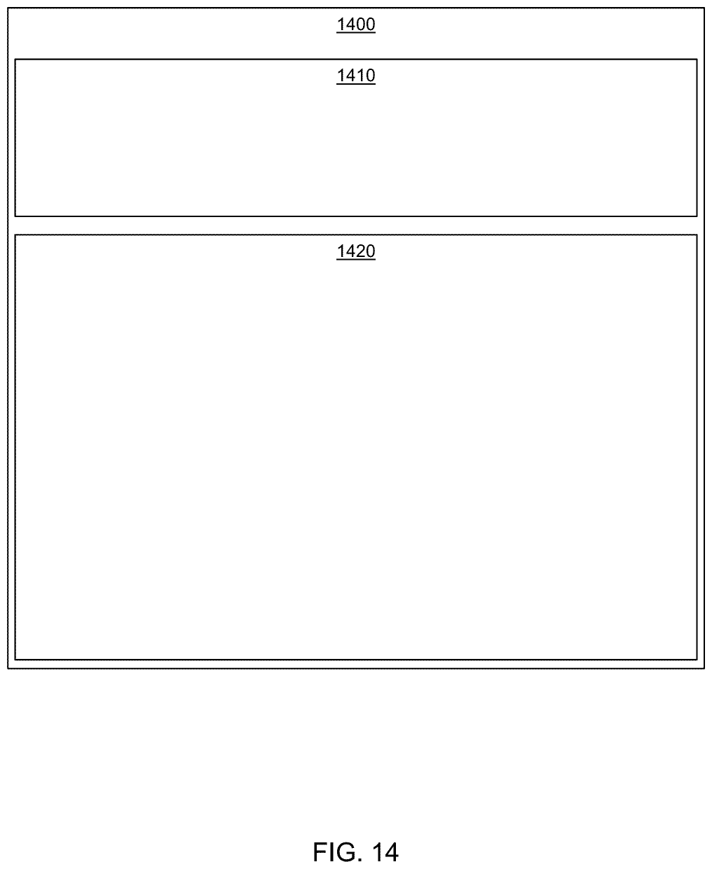

FIG. 14 depicts a user interface 1400 according to one or more exemplary embodiments. The user interface 1400 depicts a customer specific insurance application. The user interface 1400 depicts a banner message in a first frame 1410. The banner message can indicate a title of the customer specific insurance application (e.g., a ‘physicians and surgeons professional liability application’). The user interface 1400 depicts a second frame 1420, wherein the customer specific insurance application is a dynamically generated utilizing single response questions, multi-response questions, grids, dynamic displays, required rules, adding response, and removing responses.

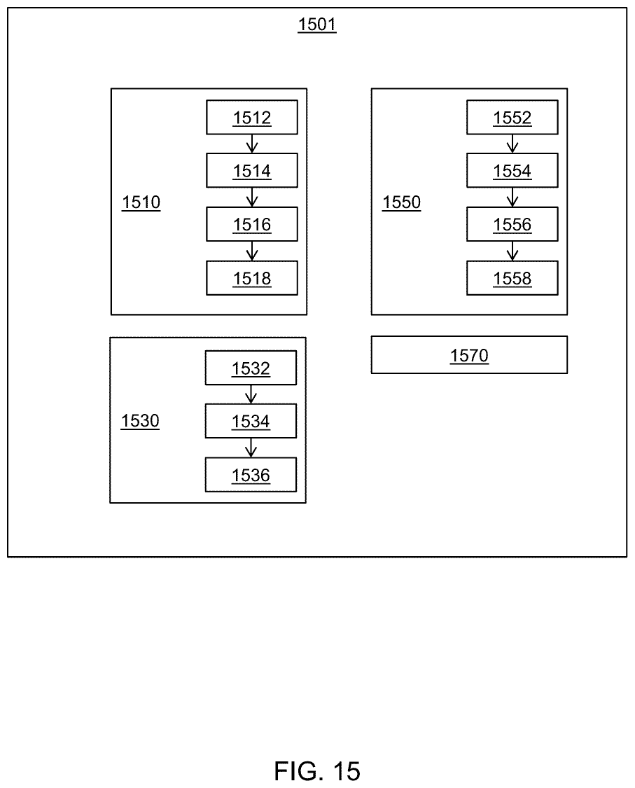

FIG. 15 depicts operation examples of a system 1501 according to one or more exemplary embodiments. The operation examples performed by the system 1501 are described herein. The operation examples include an overall process 1510, an invitation process 1530, a dynamic application building process 1550, and an authentication process 1570. The operation examples are described in the context of the disclosure herein and can incorporate any aspects of the processes, systems, and user interfaces described herein.

The overall process 1510 includes generating, at block 1512, a customer specific insurance application and providing access to a first user based on an invitation comprising a unique customer link to the customer specific insurance application. The invitation being initiated by an input from a second user. The overall process 1510 includes dynamically building and filling-in, at block 1514, the customer specific insurance application based on one or more inputs from the first user. The overall process 1510 includes on automatically populating, at block 1516, customer specific insurance application with non-standardized data to provide a completed customer specific insurance application. The overall process 1510 includes providing, at block 1518, a customized insurance request based on the completed customer specific insurance application to a third user and facilitating insurance coverage from the third user for the first user based on the customized insurance request.

The invitation process 1530 includes receiving, at block 1532, a unique identification of a first user from a second user. The invitation process 1530 includes, at block 1534, generating a unique customer link to a customer specific insurance application. The invitation process 1530 includes, at block 1536, sending an invitation including the unique customer link to the customer specific insurance application via a text message or email to the first customer. One or more technical effects, advantages, and benefits of the invitation process 1530 include preventing off-ramping by the first user as the unique customer link provides a direct path to the customer specific insurance application.

The dynamic application building process 1550 includes presenting, at block 1552, via a user interface, a customer specific insurance application. The dynamic application building process 1550 includes, at block 1554, receiving one or more inputs including non-standardized information. According to one or more embodiments, dynamic application building process 1550 can include flexibility for a second user to complete portions of the customer specific insurance application on behalf of the first user based on first user authorization, first user input user, and/or to initiate the customer specific insurance application. The dynamic application building process 1550 includes, at block 1556, dynamically modifying the customer specific insurance application based on the one or more inputs by adding questions and corresponding fields. The dynamic application building process 1550 includes, at block 1558, determining the customer specific insurance application is a completed customer specific insurance application to provide a customized insurance request.

The authentication process 1570 includes providing authentication operations across one or more layers to a first user, a second user, and a third user. Note that each of the one or more layers includes a different authentication method and level. Further, the one or more layers includes a wholesale broker layer for the third user, a retail agent layer for the second user, and an insurance applicant layer for the first user. Each layer of the one or more layers is responsible for administering access to users on that layer and sub-layers. For example, a third user has administration capabilities on the wholesale broker layer for third users of the wholesale broker layer and for second users of the retail agent layer, and a second user has administration capabilities on the retail agent layer for second users of the retail agent layer and for first users of the insurance applicant layer (e.g., the customization application enables user access and configuration).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Examples of computer-readable media include electrical signals (transmitted over wired or wireless connections) and computer-readable storage media. Examples of computer-readable storage media include, but are not limited to, a register, cache memory, semiconductor memory devices, magnetic media such as internal hard disks and removable disks, magneto-optical media, optical media such as compact disks (CD) and digital versatile disks (DVDs), a random access memory (RAM), a read-only memory (ROM), an erasable programmable read-only memory (EPROM or Flash memory), a static random access memory (SRAM), and a memory stick. A processor in association with software may be used to implement a radio frequency transceiver for use in a terminal, base station, or any host computer.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented by a system comprising at least one processor and a memory storing processor executable code for a customization engine, the method comprising:
generating, by the customization engine, a customer specific insurance application specific to a first user;
providing, by the customization engine, access to the customer specific insurance application for the first user in an invitation comprising a unique customer link, the invitation being initiated by an input from a second user;
dynamically, by the customization engine, building and filling-in the customer specific insurance application based on one or more inputs from the first user and on automatically populating customer specific insurance application with non-standardized data to provide a completed customer specific insurance application;
providing, by the customization engine, a customized insurance request based on the completed customer specific insurance application to a third user; and
facilitating, by the customization engine, insurance coverage from the third user for the first user based on the customized insurance request.

2. The method of claim 1, wherein the customer specific insurance application is generated from a dynamic insurance application template configurable by the customization engine for the first user.

3. The method of claim 2, wherein the dynamic insurance application template comprises an unfilled application for insurance coverage for the first user that is modified by the customization engine at a direction of and an input from the second user.

4. The method of claim 2, wherein the customization engine receives a unique identification for a user account for the first user, generates a unique customer link and a pin for the unique identification, and automatically generates the customer specific insurance application using the dynamic insurance application template, the user account associated with an email address, and non-standardized information in a non-standardized format within the user account.

5. The method of claim 2, wherein the customization engine automatically populates one or more empty answer fields of the dynamic insurance application template based on data for the first user by obtaining and manipulating non-standardized information into a standardized format of the customer specific insurance application.

6. The method of claim 1, wherein the first user comprises a customer, the second user comprises a retail broker or an agent that represents the first user, and the third user comprises a wholesale broker or an insurance company that issues the insurance coverage.

7. The method of claim 1, wherein the customization engine initiates access to the customer specific insurance application for the first user by performing one or more authentication operations.

8. The method of claim 1, wherein the customization engine dynamically builds the customer specific insurance application by adapting the customer specific insurance application to the one or more inputs by adding questions and corresponding fields requesting for additional information from the first user.

9. The method of claim 1, wherein the customized insurance request identifies one or more coverage characteristics in a standardized form that the third user processes for insuring the first user.

10. The method of claim 1, wherein the customization engine automatically provides the insurance coverage to the first user by generating and providing documentation comprising proof of coverage.

11. A computer program product for a customization engine, the computer program product being stored on a memory and executable by at least one processor to cause:
generating, by the customization engine, a customer specific insurance application specific to a first user;
providing, by the customization engine, access to the customer specific insurance application for the first user in an invitation comprising a unique customer link, the invitation being initiated by an input from a second user;
dynamically, by the customization engine, building and filling-in the customer specific insurance application based on one or more inputs from the first user and on automatically populating customer specific insurance application with non-standardized data to provide a completed customer specific insurance application;
providing, by the customization engine, a customized insurance request based on the completed customer specific insurance application to a third user; and
facilitating, by the customization engine, insurance coverage from the third user for the first user based on the customized insurance request.

12. The computer program product of claim 11, wherein the customer specific insurance application is generated from a dynamic insurance application template configurable by the customization engine for the first user.

13. The computer program product of claim 12, wherein the dynamic insurance application template comprises an unfilled application for insurance coverage for the first user that is modified by the customization engine at the direction of and input from the second user.

14. The computer program product of claim 12, wherein the customization engine receives a unique identification for a user account for the first user, generates a unique customer link and a pin for the unique identification, and automatically generates the customer specific insurance application using the dynamic insurance application template, the user account associated with the email address, and non-standardized information in a non-standardized format within the user account.

15. The computer program product of claim 12, wherein the customization engine automatically populates one or more empty answer fields of the dynamic insurance application template based on data for the first user by obtaining and manipulating non-standardized information into a standardized format of the customer specific insurance application.

16. The computer program product of claim 11, wherein the first user comprises a customer, the second user comprises a retail broker or an agent that represents the first user, and the third user comprises a wholesale broker or an insurance company that issues the insurance coverage.

17. The computer program product of claim 11, wherein the customization engine initiates access to the customer specific insurance application for the first user by performing one or more authentication operations.

18. The computer program product of claim 11, wherein the customization engine dynamically builds the customer specific insurance application by adapting the customer specific insurance application to the one or more inputs by adding questions and corresponding fields requesting for additional information from the first user.

19. The computer program product of claim 11, wherein the customized insurance request identifies one or more coverage characteristics in a standardized form that the third user processes for insuring the first user.

20. The computer program product of claim 11, wherein the customization engine automatically provides the insurance coverage to the first user by generating and providing documentation comprising proof of coverage.
